(19) United States
(12) Patent Application Publication
(10) Pub. No.: US 2026/0115690 A1
(43) Pub. Date: Apr. 30, 2026

(54) PREPARATION METHOD FOR SPHERICAL WATER-ABSORBENT RESIN

(71) Applicants: ZHEJIANG TRIPLE WIN NEW MATERIAL CO., LTD., Jiaxing, Zhejiang (CN); SHANGHAI CHUANGSHI MEDICAL TECHNOLOGY (GROUP) CO., LTD., Shanghai (CN)

(72) Inventors: Litao FAN, Jiaxing, Zhejiang (CN); Yan LI, Jiaxing, Zhejiang (CN); Chengyu ZHANG, Jiaxing, Zhejiang (CN); Qinhua ZHOU, Jiaxing, Zhejiang (CN)

(21) Appl. No.: 19/156,928

(22) PCT Filed: Dec. 20, 2023
(86) PCT No.: PCT/CN2023/140275

§ 371 Date: Aug. 15, 2025

(30) Foreign Application Priority Data
Feb. 16, 2023 (CN) 202310119765.6

(51) Int. Cl. B01J 20/26; B01J 20/28; B01J 20/30

(52) U.S. Cl. CPC B01J 20/267; B01J 20/28004; B01J 20/28019; B01J 20/3085

(57) ABSTRACT

Provided is a preparation method of a spherical water-absorbent resin. The spherical water-absorbent resin is produced mainly by adding reaction droplets including a water-soluble monomer, a polymerizable monofunctional group-containing long-chain crystalline polymer, an initiator, a crosslinking agent, and additives to an oily medium and allowing natural settlement and suspension polymerization. In the spherical water-absorbent resin of the present disclosure, the polymerizable monofunctional group-containing long-chain crystalline polymer with a specific crystallization capacity and the water-soluble monomer are added and co-polymerized to produce water-absorbent beads with long side-chain crystalline polymer chain segments. As a result, the crosslinking density, crystallinity, and internal three-dimensional network structure of the water-absorbent beads can be effectively improved, and the mechanical strength can be significantly enhanced. In the present disclosure, the preparation process is adjusted, such that the spherical water-absorbent resin has a high strength, excellent particle size uniformity, and exceptional sphericity.

### TECHNICAL FIELD

The present disclosure belongs to the technical field of polymer materials, and specifically relates to a preparation method of a spherical water-absorbent resin.

### BACKGROUND

Water-absorbent resins are hydrogel materials with water as a dispersing medium. Water-absorbent resins generally have a crosslinked network structure. A water-absorbent resin can absorb water dozens to hundreds of times heavier than itself. Hydrogels have excellent flexibility, can maintain a specific shape, and can be modified by physical and chemical methods to achieve diverse functions. Due to these characteristics, hydrogels are widely used in tissue culture, wound dressings, cosmetics, hygienic materials, agricultural and forestry water-retaining agents, daily chemical products, toys, water beads, etc. However, the conventional hydrogels often exhibit insufficient strength and toughness, poor elasticity, and poor durability due to factors such as loose crosslinking, low solid content, and structural heterogenicity. Thus, the conventional hydrogels are not suitable for the practical application fields demanding excellent homogeneity, high stability, and high strength, such as the field of water beads for toy guns. The patent CN103130942B discloses a preparation method of a spherical water-absorbent resin. In this patent, an aqueous solution of a methacrylic acid monomer or an ester derivative thereof is subjected to polymerization in an oil phase to produce the spherical water-absorbent resin.

The patent CN100418586C discloses a water-absorbent resin composition and a production method thereof. In this patent, a water-absorbent resin is allowed to undergo a surface treatment with a polyol and a polyvalent metal salt to produce the water-absorbent resin composition. The water-absorbent resin composition has a large absorption capacity and excellent physical properties and can withstand the physical damage during an actual production or use process. However, in this production method, multiple treatments are required for the water-absorbent resin, resulting in a complex process. Moreover, only the surface of the resin can be enhanced, and the overall performance of the resin cannot be improved.

To further improve the performance of hydrogel resins, researchers have explored various structural and molecular engineering approaches. Although some achievements have been made, it is still very difficult to achieve the large-scale preparation of high-strength hydrogel materials. Researchers such as M. Hua et al. (Nature, 2021, 590, 594-599) adopt polyvinyl alcohol (PVA) as a template, and treat a PVA hydrogel through the combination of directional freezing and saline precipitation, such that a honeycomb micro-network structure with orderly-arranged pore walls is formed and polymer chains are concentrated and densely packed in the hydrogel. During the subsequent salt precipitation process, the pre-concentrated PVA chains undergo intense aggregation, and are precipitated from a homogeneous phase to form nanofiber network structures on micro-scale aligned pore walls. As a result, a stable crystalline structure is formed to produce a hydrogel material with exceptional strength, toughness, and fatigue resistance.

The patent CN110746614A discloses a preparation method of a physical hydrogel with high strength and impact resistance. In this patent, a three-dimensional network is formed through the crosslinking of a polymerizable charged monomer, a neutral polymer, and a metal ion. Rigid molecular chains resulting from the self-polymerization of the charged monomer are crosslinked with the flexible polymer through non-covalent interactions. The metal ion can destruct a hydration shell of the charged polymer to allow the salting-out effect, such that molecular chains aggregate to produce the high-strength physical hydrogel. This method has relatively low efficiency, and is not suitable for industrial production.

### SUMMARY

In view of the shortcomings in the prior art, an objective of the present disclosure is to provide a spherical water-absorbent resin with high mechanical strength, uniform particle size, and excellent sphericity, and a preparation method thereof.

To solve the technical problems, the present disclosure adopts the following technical solutions: A preparation method of a spherical water-absorbent resin is provided, where the spherical water-absorbent resin is obtained by adding reaction droplets including a water-soluble monomer, a polymerizable monofunctional group-containing long-chain crystalline polymer, an initiator, a crosslinking agent, and additives to an oily medium, and allowing natural settlement and suspension polymerization, where the additives include a pigment and a thickening agent; and the preparation method includes the following specific steps:
S1, reaction solution preparation: mixing 20 to 50 parts by weight of the water-soluble monomer, 0.5 to 5 parts by weight of the polymerizable monofunctional group-containing long-chain crystalline polymer, 0.01 to 0.5 part by weight of the crosslinking agent, 0.01 to 0.5 part by weight of the initiator, 0 to 10 parts by weight of the pigment, 0 to 5 parts by weight of the thickening agent, and the balance of water thoroughly to produce an aqueous reaction solution;
S2, droplet formation: delivering the aqueous reaction solution obtained in the S1 to a droplet-forming storage tank, preparing reaction droplets from the aqueous reaction solution by the droplet-forming storage tank, and adding the reaction droplets dropwise to the oily medium in a polymerization tower to produce spherical reaction droplets;
S3, polymerization: allowing the spherical reaction droplets obtained in the S2 to undergo a polymerization reaction in the oily medium at 70° C. to 95° C. to produce a spherical water-absorbent resin phase, and under an action of gravity, allowing the spherical water-absorbent resin phase to naturally settle from a top of the polymerization tower to a curing tank at a bottom;
S4, curing: fully curing the spherical water-absorbent resin phase obtained in the S3 in the curing tank for 10 min to 30 min to produce a cured spherical water-absorbent resin;
S5, centrifugation: conducting centrifugal filtration for the cured spherical water-absorbent resin obtained in the S4 to remove the oily medium to produce a crude spherical water-absorbent resin;
S6, pre-drying: pre-drying the crude spherical water-absorbent resin obtained in the S5 at 50° C. to 80° C. for 1 h to 2 h to produce a pre-dried spherical water-absorbent resin;
S7, drying: drying the pre-dried spherical water-absorbent resin obtained in the S6 at 80° C. to 110° C. for 1 h to 4 h to produce spherical water-absorbent resin particles with a small amount of the oily medium on a surface, where the selection of the drying temperature is restricted by a softening temperature of the resin because the migration of moisture, residual monomers, solvent volatiles, etc. from an inside to a surface of the resin during a drying process requires a specified mass transfer time and is affected by kinetic factors; the higher the drying temperature and the lower the moisture content of the drying medium, the higher the drying rate and the shorter the drying time required; if the drying temperature is too high, the drying rate will be too high and the spherical water-absorbent resin particles will easily undergo uneven heating to cause an internal stress; and thus, dry spherical water-absorbent resin particles produced at a too-high drying temperature are prone to breakage upon subsequent swelling;
S8, cooling: slowly cooling the spherical water-absorbent resin particles with a small amount of the oily medium on a surface obtained in the S7 for 0.5 h to 2 h with low-temperature air at 30° C. to 80° C.;
S9, washing: washing spherical water-absorbent resin particles cooled to 40° C. or lower for removing the oily medium on a surface;
S10, sieving: sieving spherical water-absorbent resin particles with different particle sizes by a sieve to select spherical water-absorbent resin particles with a particle size preferably of 1 mm to 5 mm; and
S11, packaging: hermetically packaging the spherical water-absorbent resin particles with the particle size of 1 mm to 5 mm to produce a finished product.

Further, the water-soluble monomer is one or a mixture of two or more selected from the group consisting of acrylic acid and a salt thereof, methacrylic acid and a salt thereof, acrylamide, vinylbenzenesulfonic acid and a salt thereof, 2-acrylamido-2-methylpropanesulfonic acid and a salt thereof, hydroxyethyl acrylate, hydroxypropyl acrylate, hydroxyethyl methacrylate, and hydroxypropyl methacrylate.

Further, the salt of the acrylic acid is produced by neutralizing the acrylic acid with an alkali; the salt of the methacrylic acid is produced by neutralizing the methacrylic acid with an alkali; the alkali is one or more selected from the group consisting of sodium hydroxide, potassium hydroxide, sodium carbonate, sodium bicarbonate, potassium carbonate, ammonia water, triethanolamine, ethylenediamine, and aminomethyl propanol; and a molar ratio of the acrylic acid or the methacrylic acid to the alkali is 1:(0.7-1).

Further, the polymerizable monofunctional group-containing long-chain crystalline polymer is a water-soluble long-chain crystalline polymer with a vinyl group, and has a general formula of

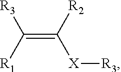

where R₁ is —H or —CH₃, R₂ is —H or —CH₃, X is a linking group including an ether group —CH₂O—, an acyloxy group —C(═O)—O—, or an amido group —C(═O)—NH—, and R₃ is a polyethylene glycol, polypeptide, PVA, polylactic acid (PLA), polycaprolactone (PCL), cellulose, polysaccharide, or polyurethane chain segment; and the polymerizable monofunctional group-containing long-chain crystalline polymer is added in 0.5 to 5 parts by weight.

Further, the crosslinking agent is one or a mixture of two or more selected from the group consisting of N,N′-methylenebisacrylamide, polyethylene glycol dimethacrylate, pentaerythritol triallyl ether, diethylene glycol diglycidyl ether, and a polyvalent metal salt; and the crosslinking agent is added in 0.01 to 0.5 part by weight.

Furthermore, a metal ion in the polyvalent metal salt is any one selected from the group consisting of Al³⁺, Fe³⁺, Cu²⁺, Ca²⁺, Mg²⁺, and Si⁴⁺.

Further, the initiator is at least one selected from the group consisting of potassium persulfate, sodium persulfate, ammonium persulfate, azo initiators, hydrogen peroxide, and redox initiators.

Further, the pigment includes one or a mixture of two or more selected from the group consisting of an organic pigment, an inorganic pigment, a luminous agent, and a thermosensitive color-changing microcapsule; and the thickening agent is one or a mixture of two or more selected from the group consisting of hydroxyethyl cellulose, hydroxypropyl cellulose, carboxymethyl cellulose, a polysaccharide derivative, sodium polyacrylate, PVA, polyethylene glycol, and polyvinylpyrrolidone.

Further, the oily medium is a hydrophobic high-temperature-resistant oily liquid, and includes one or a mixture of two or more selected from the group consisting of liquid paraffin, epoxy soybean oil, polydimethylsiloxane, an aromatic hydrocarbon, an alkane, a hydrophobic polyether, a long-chain polyester, and a poly-α-olefin; and a rotational viscosity of the oily medium at 25° C. is 100 mPa·s to 1,000 mPa·s. The viscosity of the oily medium is very important. If the viscosity is too low, a residence time of the reaction droplets in the polymerization tower will be too short, and a reaction will be incomplete. If the viscosity is too high, the reaction droplets are difficult to fall and are prone to aggregation, resulting in uneven sizes of the spherical water-absorbent resin. The high-temperature-resistant oily liquid must have excellent thermal and chemical stability, oxidation resistance, and a high boiling point, is not easy to chemically react with polymer monomers, exhibits poor monomer solubility, and is not prone to transformation under long-term high-temperature heating. Moreover, the oily liquid needs to be easily removed through centrifugation, and thus can be fully removed from the surface of the spherical water-absorbent resin.

Further, after absorbing water, the spherical water-absorbent resin has a particle size of 4 mm to 18 mm, and the spherical water-absorbent resin can be used in fields such as water beads for toy guns, hot/cold therapy packs, aromatherapy beads, and toys.

The present disclosure has the following beneficial effects: Compared with the prior art, the preparation method of the spherical water-absorbent resin provided by the present disclosure has the following advantages:

1) In the spherical water-absorbent resin of the present disclosure, the polymerizable monofunctional group-containing long-chain crystalline polymer with a specific crystallization capacity and the water-soluble monomer are added and co-polymerized to produce water-absorbent beads with long side-chain crystalline polymer chain segments. As a result, the crosslinking density, crystallinity, and internal three-dimensional network structure of the spherical water-absorbent resin can be effectively improved, and the mechanical strength can be significantly enhanced.

2) During the preparation of the spherical water-absorbent resin, the pre-drying is conducted after the polymerization is completed. During a pre-drying process, side-chain crystalline chain segments of the polymerizable monofunctional group-containing long-chain crystalline polymer are slowly arranged orderly to form an orderly-arranged micronetwork structure. The pre-drying can remove a part of moisture, and make polymer chains concentrated and densely packed. During the subsequent drying process, polymer chain segments of the spherical water-absorbent resin will undergo intense aggregation and the moisture will evaporate constantly until a stable microcrystalline structure and three-dimensional crosslinked network structure are formed.

3) After being dried, the spherical water-absorbent resin is cooled with low-dew-point air to a temperature suitable for cleaning (usually lower than 40° C.). A cooling process for the spherical water-absorbent resin is actually accompanied by a non-isothermal crystallization process. The too-fast or steep cooling is not conducive to crystallization, and may also fail to achieve the complete cooling for the spherical water-absorbent resin. As the resin cools, the temperature of a cooling medium increases. The cooling medium absorbs the heat released during the cooling, and this portion of hot air can be reused as the entire or partial heating source for the pre-drying or pre-crystallization. Thus, the heat throughout the drying and cooling process can be recycled, which reduces the energy consumption.

4) The uncrystallized long-chain polymer side chains will undergo molecular chain entanglement, which increases the toughness of the spherical water-absorbent resin.

5) The spherical water-absorbent resin produced through natural settlement and suspension polymerization has a uniform particle size and high sphericity, and thus is suitable for application scenarios requiring high particle sphericity, such as water beads for toy guns.

### DETAILED DESCRIPTION OF THE EMBODIMENTS

The present disclosure will be further described below through specific examples. However, these examples are only intended to describe the present disclosure, rather than to limit the scope of the present disclosure.

### Test Methods:

### 1) Gel Strength

A gel strength of a water-absorbent resin was tested by a universal testing machine. Spherical water-absorbent resin particles were soaked in deionized water at 25° C. for 12 h. Spherical water-absorbent resin particles undergoing saturated absorption were placed directly below a gel strength probe, and squeezed by the gel strength probe until rupturing. A force required for the rupturing of particles was recorded and defined as the gel strength of the spherical water-absorbent resin particles.

### 2) Uniformity

After sieving, a proportion of particles with a target particle size among the total product particles was determined.

### Example 1

S1:300 g of an acrylic acid monomer, 120 g of sodium hydroxide, 50 g of an acrylamide monomer, 10 g of isopentenol polyoxyethylene ether (TPEG), 3 g of polyethylene glycol acrylate as a crosslinking agent, 1 g of potassium persulfate as an initiator, 10 g of titanium dioxide as a pigment, and 550 g of water were mixed and stirred to produce an aqueous reaction solution.

S2: Droplet formation: The aqueous reaction solution obtained in the S1 was delivered to a droplet-forming storage tank, prepared into reaction droplets by the droplet-forming storage tank, and added dropwise to epoxy soybean oil in a polymerization tower to produce spherical reaction droplets.

S3: Polymerization: The spherical reaction droplets obtained in the S2 were allowed to undergo a polymerization reaction in the oily medium at 80° C. to 90° C. to produce a spherical water-absorbent resin phase. Under an action of gravity, the spherical water-absorbent resin phase was allowed to naturally settle from a top of the polymerization tower to a curing tank at a bottom.

S4: Curing: The spherical water-absorbent resin phase obtained in the S3 was fully cured in the curing tank for 20 min to produce a cured spherical water-absorbent resin.

S5: Centrifugation: Centrifugal filtration was conducted for the cured spherical water-absorbent resin obtained in the S4 to remove the oily medium to produce a crude spherical water-absorbent resin.

S6: Pre-drying: The crude spherical water-absorbent resin obtained in the S5 was pre-dried at 60° C. for 1 h to produce a pre-dried spherical water-absorbent resin.

S7: Drying: The pre-dried spherical water-absorbent resin obtained in the S6 was dried at 100° C. for 2 h to produce spherical water-absorbent resin particles with a small amount of the oily medium on a surface.

S8: Cooling: The spherical water-absorbent resin particles with a small amount of the oily medium on a surface obtained in the S7 were slowly cooled for 1 h with low-temperature air at 30° C. to 80° C.

S9: Washing: Spherical water-absorbent resin particles cooled to 40° C. or lower were washed for removing the oily medium on a surface.

S10: Sieving: Spherical water-absorbent resin particles with different particle sizes were sieved by a sieve to select spherical water-absorbent resin particles with a particle size of 2 mm to 3 mm.

S11: Packaging: The spherical water-absorbent resin particles with the particle size of 2 mm to 3 mm were hermetically packaged to produce a finished product of white spherical water-absorbent resin particles.

### Example 2

S1: 2,000 g of an acrylic acid monomer, 800 g of triethanolamine, 400 g of sodium hydroxide, 500 g of hydroxypropyl acrylate, 200 g of polyethylene glycol monomethallyl ether (HPEG), 10 g of N,N′-methylenebisacrylamide as a crosslinking agent, 10 g of potassium persulfate as an initiator, and 3,500 g of water were mixed and stirred to produce an aqueous reaction solution.

S2 to S11 were the same as in Example 1. A finished product of transparent spherical water-absorbent resin particles was produced.

### Example 3

S1: 1,500 g of an acrylic acid monomer, 740 g of sodium hydroxide, 200 g of hydroxyethyl acrylate, 100 g of HPEG, 6 g of polyethylene glycol diacrylate as a crosslinking agent, 5 g of potassium persulfate as an initiator, 20 g of sodium carboxymethyl cellulose as a thickening agent, 15 g of a red pigment, and 2,500 g of water were mixed and stirred to produce an aqueous reaction solution.

S2 to S11 were the same as in Example 1. A finished product of red spherical water-absorbent resin particles was produced.

### Example 4

S1: 1,500 g of an acrylic acid monomer, 740 g of sodium hydroxide, 50 g of methoxy polyethylene glycol monomethacrylate, 3 g of polyethylene glycol diacrylate as a crosslinking agent, 4 g of potassium persulfate as an initiator, 40 g of sodium carboxymethyl cellulose as a thickening agent, 70 g of a luminous powder, and 2,000 g of water were mixed and stirred to produce an aqueous reaction solution.

S2 to S11 were the same as in Example 1. A finished product of phosphorescent spherical water-absorbent resin particles was obtained, which could absorb light and emit luminescence in the dark.

### Example 5

S1: 1,500 g of an acrylic acid monomer, 740 g of sodium hydroxide, 200 g of hydroxyethyl acrylate, 30 g of polyurethane acrylate, 6 g of polyethylene glycol diacrylate as a crosslinking agent, 5 g of potassium persulfate as an initiator, 20 g of sodium carboxymethyl cellulose as a thickening agent, 150 g of a luminous powder, and 2,500 g of water were mixed and stirred to produce an aqueous reaction solution.

S2 to S11 were the same as in Example 1. A finished product of phosphorescent spherical water-absorbent resin particles was obtained, which could absorb light and emit luminescence in the dark.

### Example 6

S1: 2,000 g of an acrylic acid monomer, 800 g of sodium hydroxide, 500 g of hydroxypropyl acrylate, 200 g of polylactic acid monoacrylate, 10 g of polyethylene glycol diacrylate as a crosslinking agent, 10 g of potassium persulfate as an initiator, and 3,500 g of water were mixed and stirred to produce an aqueous reaction solution.

S2 to S11 were the same as in Example 1. A finished product of transparent spherical water-absorbent resin particles was produced.

### Comparative Example 1

S1: 300 g of an acrylic acid monomer, 120 g of sodium hydroxide, 50 g of an acrylamide monomer, 3 g of polyethylene glycol acrylate as a crosslinking agent, 1 g of potassium persulfate as an initiator, 10 g of titanium dioxide as a pigment, and 550 g of water were mixed and stirred to produce an aqueous reaction solution.

S2 to S11 were the same as in Example 1. A finished product of white spherical water-absorbent resin particles was produced.

### Comparative Example 2

S1:300 g of an acrylic acid monomer, 120 g of sodium hydroxide, 50 g of an acrylamide monomer, 10 g of isopentenol polyoxyethylene ether (TPEG), 3 g of polyethylene glycol acrylate as a crosslinking agent, 1 g of potassium persulfate as an initiator, 10 g of titanium dioxide as a pigment, and 550 g of water were mixed and stirred to produce an aqueous reaction solution.

S2: Droplet formation: The aqueous reaction solution obtained in the S1 was delivered to a droplet-forming storage tank, prepared into reaction droplets by the droplet-forming storage tank, and added dropwise to epoxy soybean oil in a polymerization tower to produce spherical reaction droplets.

S3: Polymerization: The spherical reaction droplets obtained in the S2 were allowed to undergo a polymerization reaction in the oily medium at 80° C. to 90° C. to produce a spherical water-absorbent resin phase. Under an action of gravity, the spherical water-absorbent resin phase was allowed to naturally settle from a top of the polymerization tower to a curing tank at a bottom.

S4: Curing: The spherical water-absorbent resin phase obtained in the S3 was fully cured in the curing tank for 20 min to produce a cured spherical water-absorbent resin.

S5: Centrifugation: Centrifugal filtration was conducted for the cured spherical water-absorbent resin obtained in the S4 to remove the oily medium to produce a crude spherical water-absorbent resin.

S6: Drying: The crude spherical water-absorbent resin obtained in the S5 was dried at 100° C. for 3 h to produce spherical water-absorbent resin particles with a small amount of the oily medium on a surface.

S7: Cooling: The spherical water-absorbent resin particles with a small amount of the oily medium on a surface obtained in the S6 were slowly cooled for 1 h with low-temperature air at 30° C. to 80° C.

S8: Washing: Spherical water-absorbent resin particles cooled to 40° C. or lower were washed for removing the oily medium on a surface.

S9: Sieving: Spherical water-absorbent resin particles with different particle sizes were sieved by a sieve to select spherical water-absorbent resin particles with a particle size of 2 mm to 3 mm.

S10: Packaging: The spherical water-absorbent resin particles with the particle size of 2 mm to 3 mm were hermetically packaged to produce a finished product of white spherical water-absorbent resin particles.

### Comparative Example 3

S1: 1,500 g of an acrylic acid monomer, 740 g of sodium hydroxide, 3 g of polyethylene glycol diacrylate as a crosslinking agent, 4 g of potassium persulfate as an initiator, 40 g of sodium carboxymethyl cellulose as a thickening agent, 70 g of a luminous powder, and 2,000 g of water were mixed and stirred to produce an aqueous reaction solution.

S2 to S11 were the same as in Example 1. Water-absorbent phosphorescent beads were obtained, which could absorb light and emit luminescence in the dark.

### Performance Testing Results:

The products obtained in the examples and comparative examples each were tested for performance, and test results were shown in the following table:

| Example | Gel strength (N) | Uniformity (%) |
|---|---|---|
| Example 1 | 25 | 97 |
| Example 2 | 35 | 96 |
| Example 3 | 20 | 98 |
| Example 4 | 18 | 97 |
| Example 5 | 21 | 96 |
| Example 6 | 17 | 96 |
| Comparative Example 1 | 10 | 95 |
| Comparative Example 2 | 16 | 92 |
| Comparative Example 3 | 6 | 94 |

After the spherical water-absorbent resin in Comparative Example 2 was soaked in deionized water until saturated, about 30% of the spherical water-absorbent resin ruptures and is broken. When the pre-drying procedure is omitted, a drying rate is too high, and an internal stress is easily formed. As a result, after re-absorbing water, the water-absorbent resin is broken and cannot be used.

The above implementations are provided merely to describe the present disclosure rather than to limit the present disclosure. Those of ordinary skill in the relevant technical field can make various variations and modifications without departing from the spirit and scope of the present disclosure. Therefore, all equivalent technical solutions should also fall within the protection scope of the present disclosure. The protection scope of the present disclosure shall be defined by the claims.

What is claimed is:

1. A preparation method of a spherical water-absorbent resin, wherein the spherical water-absorbent resin is obtained by adding reaction droplets comprising a water-soluble monomer, a polymerizable monofunctional group-containing long-chain crystalline polymer, an initiator, a crosslinking agent, and additives to an oily medium, and allowing natural settlement and suspension polymerization, and the additives comprise a pigment and a thickening agent; and the preparation method comprises the following specific steps:
S1, reaction solution preparation: mixing 20 to 50 parts by weight of the water-soluble monomer, 0.5 to 5 parts by weight of the polymerizable monofunctional group-containing long-chain crystalline polymer, 0.01 to 0.5 part by weight of the crosslinking agent, 0.01 to 0.5 part by weight of the initiator, 0 to 10 parts by weight of the pigment, 0 to 5 parts by weight of the thickening agent, and the balance of water thoroughly to produce an aqueous reaction solution;
S2, droplet formation: delivering the aqueous reaction solution obtained in the S1 to a droplet-forming storage tank, preparing reaction droplets from the aqueous reaction solution by the droplet-forming storage tank, and adding the reaction droplets dropwise to the oily medium in a polymerization tower to produce spherical reaction droplets;
S3, polymerization: allowing the spherical reaction droplets obtained in the S2 to undergo a polymerization reaction in the oily medium at 70° C. to 95° C. to produce a spherical water-absorbent resin phase, and under an action of gravity, allowing the spherical water-absorbent resin phase to naturally settle from a top of the polymerization tower to a curing tank at a bottom;
S4, curing: fully curing the spherical water-absorbent resin phase obtained in the S3 in the curing tank for 10 min to 30 min to produce a cured spherical water-absorbent resin;
S5, centrifugation: conducting centrifugal filtration for the cured spherical water-absorbent resin obtained in the S4 to remove the oily medium to produce a crude spherical water-absorbent resin;
S6, pre-drying: pre-drying the crude spherical water-absorbent resin obtained in the S5 at 50° C. to 80° C. for 1 h to 2 h to produce a pre-dried spherical water-absorbent resin;
S7, drying: drying the pre-dried spherical water-absorbent resin obtained in the S6 at 80° C. to 110° C. for 1 h to 4 h;
S8, cooling: slowly cooling spherical water-absorbent resin particles with a small amount of the oily medium on a surface obtained in the S7 for 0.5 h to 2 h with low-temperature air at 30° C. to 80° C.;
S9, washing: washing spherical water-absorbent resin particles cooled to 40° C. or lower for removing the oily medium on a surface;
S10, sieving: sieving spherical water-absorbent resin particles with different particle sizes by a sieve to select spherical water-absorbent resin particles with a particle size of 1 mm to 5 mm; and
S11, packaging: hermetically packaging the spherical water-absorbent resin particles with the suitable particle size to produce a finished product.

2. The preparation method of the spherical water-absorbent resin according to claim 1, wherein the water-soluble monomer is one or a mixture of two or more of acrylic acid and a salt thereof, methacrylic acid and a salt thereof, acrylamide, vinylbenzenesulfonic acid and a salt thereof, 2-acrylamido-2-methylpropanesulfonic acid and a salt thereof, hydroxyethyl acrylate, hydroxypropyl acrylate, hydroxyethyl methacrylate, and hydroxypropyl methacrylate.

3. The preparation method of the spherical water-absorbent resin according to claim 2, wherein the acrylic acid and a salt thereof is produced by neutralizing the acrylic acid with an alkali; the methacrylic acid and the salt thereof is produced by neutralizing the methacrylic acid with an alkali; the alkali is one or more selected from the group consisting of sodium hydroxide, potassium hydroxide, sodium carbonate, sodium bicarbonate, potassium carbonate, ammonia water, triethanolamine, ethylenediamine, and aminomethyl propanol; and a molar ratio of the acrylic acid or the methacrylic acid to the alkali is 1:(0.7-1).

4. The preparation method of the spherical water-absorbent resin according to claim 1, wherein the polymerizable monofunctional group-containing long-chain crystalline polymer is a water-soluble long-chain crystalline polymer with a vinyl group, and has a general formula of 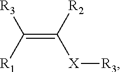
wherein R₁ is —H or —CH₃, R₂ is —H or —CH₃, X is a linking group comprising an ether group —CH₂O—, an acyloxy group —C(═O)—O—, or an amido group —C(═O)—NH—, and R₃ is a polyethylene glycol, polypeptide, polyvinyl alcohol (PVA), polylactic acid (PLA), polycaprolactone (PCL), cellulose, polysaccharide, or polyurethane chain segment; and the polymerizable monofunctional group-containing long-chain crystalline polymer is added in 0.5 to 5 parts by weight.

5. The preparation method of the spherical water-absorbent resin according to claim 1, wherein the crosslinking agent is one or a mixture of two or more of N,N′-methylenebisacrylamide, polyethylene glycol dimethacrylate, pentaerythritol triallyl ether, diethylene glycol diglycidyl ether, and a polyvalent metal salt; the crosslinking agent is added in 0.01 to 0.5 part by weight; and a metal ion in the polyvalent metal salt is any one selected from the group consisting of Al³⁺, Fe³⁺, Cu²⁺, Ca²⁺, Mg²⁺, and Si⁴⁺.

6. The preparation method of the spherical water-absorbent resin according to claim 1, wherein the initiator is at least one selected from the group consisting of potassium persulfate, sodium persulfate, ammonium persulfate, azo initiators, hydrogen peroxide, and redox initiators.

7. The preparation method of the spherical water-absorbent resin according to claim 1, wherein the pigment comprises one or a mixture of two or more of an organic pigment, an inorganic pigment, a luminous agent, and a thermosensitive color-changing microcapsule; and the thickening agent is one or a mixture of two or more of hydroxyethyl cellulose, hydroxypropyl cellulose, carboxymethyl cellulose, a polysaccharide derivative, sodium polyacrylate, PVA, polyethylene glycol, and polyvinylpyrrolidone.

8. The preparation method of the spherical water-absorbent resin according to claim 1, wherein the oily medium is a hydrophobic high-temperature-resistant oily liquid, and comprises one or a mixture of two or more of liquid paraffin, epoxy soybean oil, polydimethylsiloxane, an aromatic hydrocarbon, an alkane, a hydrophobic polyether, a long-chain polyester, and a poly-α-olefin; and a rotational viscosity of the oily medium at 25° C. is 100 mPa·s to 1,000 mPa·s.

9. The preparation method of the spherical water-absorbent resin according to claim 1, wherein after absorbing water, the spherical water-absorbent resin has a particle size of 4 mm to 18 mm, and the spherical water-absorbent resin is suitable for fields of water beads for toy guns, hot/cold therapy packs, aromatherapy beads, and toys.
